(19) United States
(12) Patent Application Publication
(10) Pub. No.: US 2008/0232840 A1
(43) Pub. Date: Sep. 25, 2008

(54) IMAGE FORMING APPARATUS AND METHOD OF THE SAME

(75) Inventor: Hideyuki Ebihara, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/688,553

(22) Filed: Mar. 20, 2007

(51) Int. Cl. G03G 21/02

(52) U.S. Cl. 399/79; 399/80

(57) ABSTRACT

The number of prints necessary for execution of a print job of a storage type, together with the surplus number of prints, is calculated. A difference B between an upper limit value A and the number C of prints is calculated during execution of a print job. When there is a print job of the storage type having the number of prints not lower than the difference B, notification that the upper limit value of the number of prints approaches is given to a user having issued the print job.

### BACKGROUND OF THE INVENTION

1. Field of the Invention

The present invention relates to an image forming apparatus to print an image on a sheet and a control method of the same.

2. Description of the Related Art

As an example of an image forming apparatus to print an image on a sheet, there is one having a function to limit the number of prints. In this image forming apparatus, the upper limit value of the number of prints can be set for each user or each department to which the user belongs.

In the case of a print job (so-called private job or schedule print job) which is once stored in the main body of the image forming apparatus and is later executed, even if the number of prints does not reach the upper limit value at the time point when the print job is inputted, there is a case where the number of prints reaches the upper limit value during the period when another print job is being executed. In this case, completion of the stored print job becomes impossible.

### BRIEF SUMMARY OF THE INVENTION

An aspect of the invention has an object to provide an image forming apparatus in which a stored print job can be completed before the number of prints reaches an upper limit value, and a control method of the same.

An image forming apparatus according to an aspect of the invention includes

a storage section to store an upper limit value of the number of prints for each user or each department to which the user belongs;

a first determination section to determine whether, when a print job is inputted, the print job is a storage type in which it is once stored and is later executed;

a first calculation section to calculate, when a determination result of the first determination section is the storage type, the number of prints necessary for execution of the inputted print job, together with the surplus number of prints;

a plurality of management tables of the number of prints in each of which the number of prints calculated by the first calculation section is made to correspond to the inputted print job and is registered for the each user or the each department;

a count section to count the number of prints for the each user or the each department at a time of execution of the print job;

a second determination section to determine whether a count value of the count section reaches the upper limit value in the storage section for the each user having issued the print job under execution or the each department to which the user belongs;

a control section to stop the print job under execution when the count value reaches the upper limit value in determination of the second determination section;

a second calculation section to calculate, when the count value does not reach the upper limit value in the determination of the second determination section, a difference between the upper limit value and the count value for the each user having issued the print job under execution or the each department to which the user belongs;

a third determination section to select a management table of the number of prints corresponding to the user having issued the print job under execution or the department to which the user belongs among the management tables of the number of prints, and to determine whether there is a print job having the number of prints not lower than the difference calculated by the second calculation section among the respective numbers of prints registered in the selected management table of the number of prints; and

a notification section to notify, when a determination result of the third determination section is yes, the user having issued the print job that the upper limit value of the number of prints approaches.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing an outer appearance of respective embodiments.

FIG. 2 is a view showing a control panel of the respective embodiments.

FIG. 3 is a block diagram of a control circuit of the respective embodiments.

FIG. 4 is a view showing respective management tables of the number of prints according to a first embodiment.

FIG. 5 is a view showing a print job screen of a personal computer in the first embodiment.

FIG. 6 is a flowchart for explaining an operation at a time of print job input according to the first embodiment.

FIG. 7 is a view showing a state in which a new job ID and the number of prints are registered in the management table of the number of prints of FIG. 4.

FIG. 8 is a flowchart for explaining an operation at the time of print job execution according to the first embodiment.

FIG. 9 is a view showing a print job as an object of notification among respective job IDs and the respective numbers of prints registered in the management table of the number of prints of FIG. 6.

FIG. 10 is a view showing respective management tables of the number of prints according to a second embodiment.

FIG. 11 is a view showing a menu screen in the second embodiment.

FIG. 12 is a view showing a submenu screen displayed by an operation of the menu screen of FIG. 11.

FIG. 13 is a view showing a USER NOTIFICATION screen displayed by an operation of the submenu screen of FIG. 12.

FIG. 14 is a view showing a MANAGEMENT screen in the second embodiment.

FIG. 15 is a view showing a DEPARTMENT CODE screen displayed by an operation of the MANAGEMENT screen of FIG. 14.

FIG. 16 is a view showing a DEPARTMENT CODE registration screen displayed by an operation of the DEPARTMENT CODE screen of FIG. 15.

FIG. 17 is a view showing a LIMITATION setting screen displayed by an operation of the DEPARTMENT CODE registration screen of FIG. 16.

FIG. 18 is a view showing a USER NOTIFICATION setting screen displayed by an operation of the LIMITATION setting screen of FIG. 17.

FIG. 19 is a view showing a print job screen in the second embodiment.

FIG. 20 is a view showing a USER NOTIFICATION setting screen displayed by an operation of a print job screen of FIG. 19.

FIG. 21 is a flowchart for explaining an operation at the time of print job input according to the second embodiment.

FIG. 22 is a view showing a state in which a new job ID and the number of prints are registered in the management table of the number of prints of FIG. 20.

FIG. 23 is a flowchart for explaining an operation at the time of print job execution according to the second embodiment.

FIG. 24 is a view showing a print job as an object of notification among respective job IDs and the respective numbers of prints registered in the management table of the number of prints of FIG. 22.

### DETAILED DESCRIPTION OF THE INVENTION

[1] Hereinafter, a first embodiment of the invention will be described with reference to the drawings.

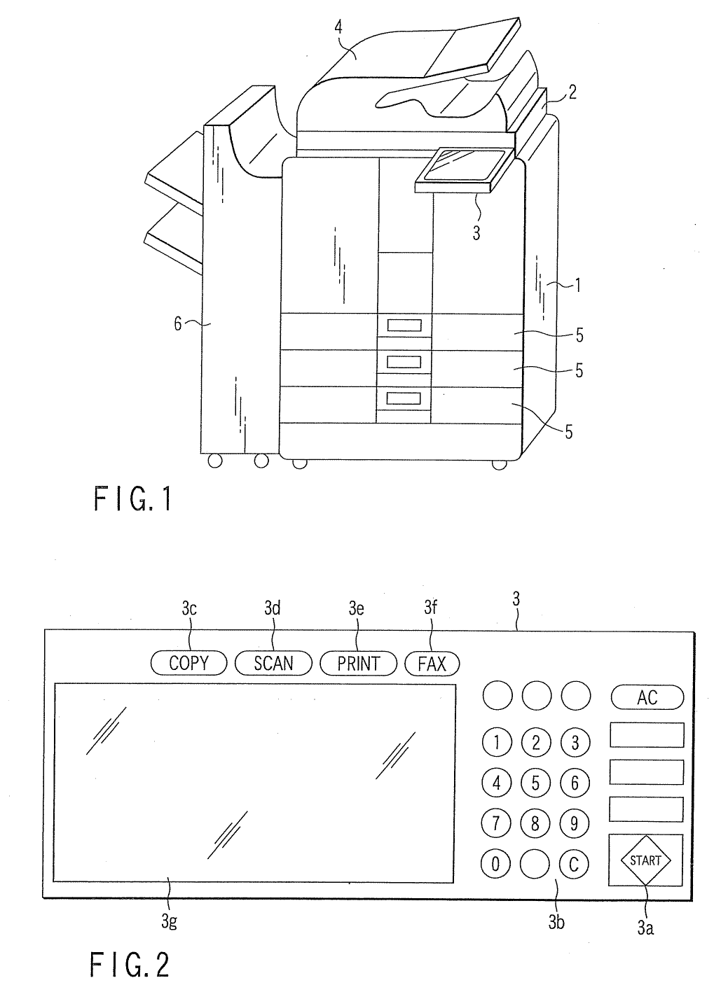

As shown in FIG. 1, a document stand 2 and a control panel 3 are provided at an upper part of a main body 1 of an image forming apparatus, and an automatic document feeder (ADF) 4 is openably and closably provided on the document stand 2. Besides, a plurality of cassettes 5 are provided at a lower part of the main body 1. Many print sheets different from each other in size are contained in these cassettes 5. The sheets are extracted one by one from any one of these cassettes 5, and an image is printed on the extracted sheet. The sheet after completion of the printing is discharged to a paper discharge unit 6.

As shown in FIG. 2, the control panel 3 includes a start key 3a, a ten-key pad 3b, a copy key 3c, a scan key 3d, a print key 3e and a facsimile key 3f, and includes a touch panel type liquid crystal display screen 3g as a display section.

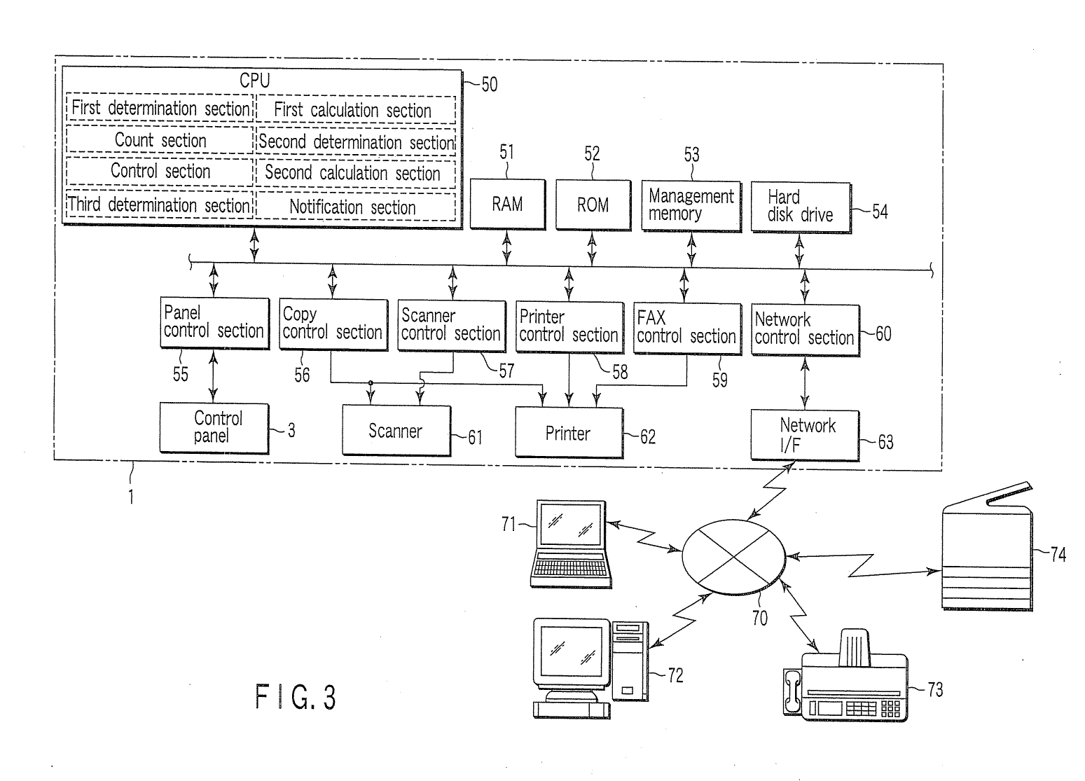

FIG. 3 shows the whole control circuit.

A CPU 50 is connected with a RAM 51, a ROM 52, a management memory 53 as a storage section, a hard disk drive 54, a panel control section 55, a copy control section 56, a scanner control section 57, a printer control section 58, a facsimile (FAX) control section 59 and a network control section 60.

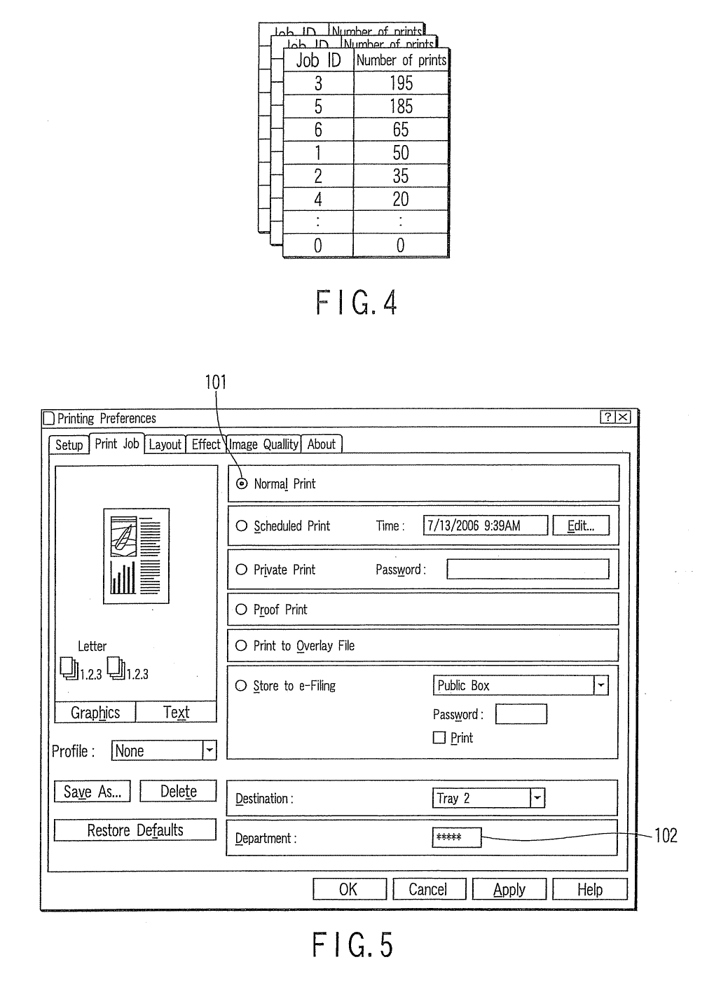

The RAM 51 is for storing various data. The ROM 52 stores various control programs necessary for the operation of the main body 1. The management memory 53 stores the upper limit value A of the number of prints for each user or each department to which the user belongs, and stores a plurality of management tables of the number of prints shown in FIG. 4. These management tables of the number of prints are divided for the respective users or the respective departments. The hard disk drive 54 stores image data scanned by the main body 1, image data transferred from an external equipment and the like.

The panel control section 55 controls the control panel 3. The copy control section 56 controls a normal copy function using a scanner 60 and a printer 61. The scanner control section 57 controls a scan function using the scanner 60 (scan to box function, scan to file function, scan to E-mail function). The printer control section 58 controls a network print function using the printer 61. The facsimile control section 59 controls a facsimile function using the printer 61.

The network control section 60 controls data transmission and reception to and from external equipments through a network interface 63. The network interface 63 includes a LAN board, a FAX modem and the like, and is connected through an external communication line 70 to, as the external equipments, personal computers 71 and 72, a facsimile apparatus 73, another image forming apparatus 74 and the like.

The CPU 50 includes next sections (1) to (8) as main functions.

(1) A first determination section to determine whether, when a print job is inputted from an external equipment, for example, a personal computer 71, the print job is a storage type in which it is once stored and is later executed. As the print job of the storage type, there is a private print job executed by password input of a user, a schedule print job executed at a scheduled time, or the like.

(2) A first calculation section to calculate, when the determination result of the first determination section is the storage type, the number of prints necessary for execution of the inputted print job, together with the surplus number of prints. The calculated number of prints is made to correspond to the inputted print job, and is registered in each management table of the number of prints in the management memory 53 for the each user or the each department.

(3) A count section to count the number C of prints for the each user or the each department at the time of execution of the print job.

(4) A second determination section to determine whether the count value C of the count section reaches the upper limit value A in the management memory 53 for the each user having issued the print job under execution or the each department to which the user belongs.

(5) A control section to stop the print job under execution when the count value C reaches the upper limit value A in determination of the second determination section.

(6) A second calculation section to calculate, when the count value C does not reach the upper limit value A in the determination of the second determination section, a difference B (=A−C) between the upper limit value A and the count value C for the each user having issued the print job under execution or the each department to which the user belongs.

(7) A third determination section to select, among the respective management tables of the number of prints in the management memory 53, a management table of the number of prints corresponding to the user having issued the print job under execution or the department to which the user belongs, and to determine whether there is a print job having the number of prints not lower than the difference B calculated by the second calculation section among the respective numbers of prints registered in the selected management table of the number of prints.

(8) A notification section to notify, when a determination result of the third determination section is yes, the user having issued the print job that the upper limit value of the number of prints approaches.

The operation will be described.

A print job screen shown in FIG. 5 is displayed on a display of an external equipment, for example, the personal computer 71, and the print job screen is operated so that a desired print job can be inputted. The print job screen includes a plurality of check windows 101 to select one of a plurality of print jobs, for example, Normal Print, Scheduled Print, Private Print, Proof Print, Print Overlay File, and Store to e-Filing, an input window 102 of DEPARTMENT CODE to represent a department to which a user belongs.

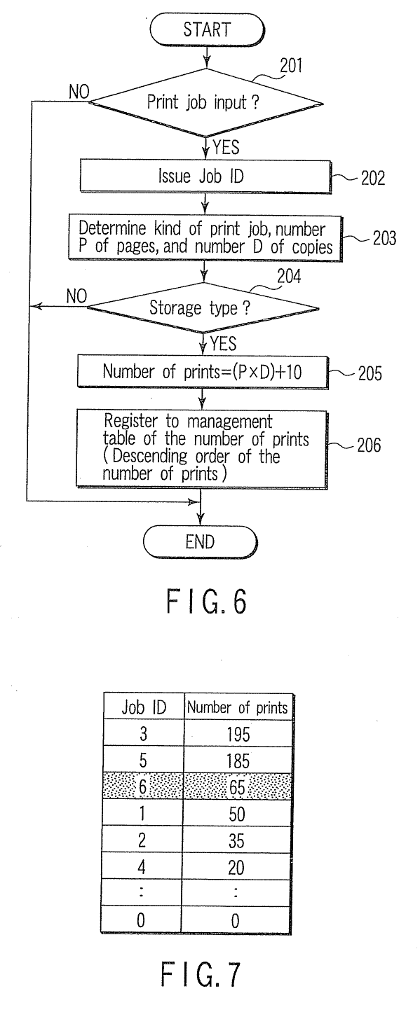

As shown in a flowchart of FIG. 6, when a print job is inputted to the main body 1 (YES at step 201), an arbitrary job ID is issued to the inputted print job (step 202), and the kind of the inputted print job, the number P of pages, and the number D of copies are determined (step 203).

When the kind of the inputted print job is the storage type in which it is once stored and is later executed, for example, the private print job or the schedule print job (YES at step 204), the number of prints necessary for execution of the print job, together with the surplus number of prints (for example, 10 sheets), is calculated (step 205).

the number of prints=(the number P of pages×the number D of copies)+the surplus number of prints

The calculated number of prints is made to correspond to the job ID of the inputted print job and is registered in each management table of the number of prints in the management memory 53 for the each user or the each department (step 206). As indicated by dots in FIG. 7, the newly registered job ID and the number of prints are registered in a state where sorting is performed in descending order of the number of prints.

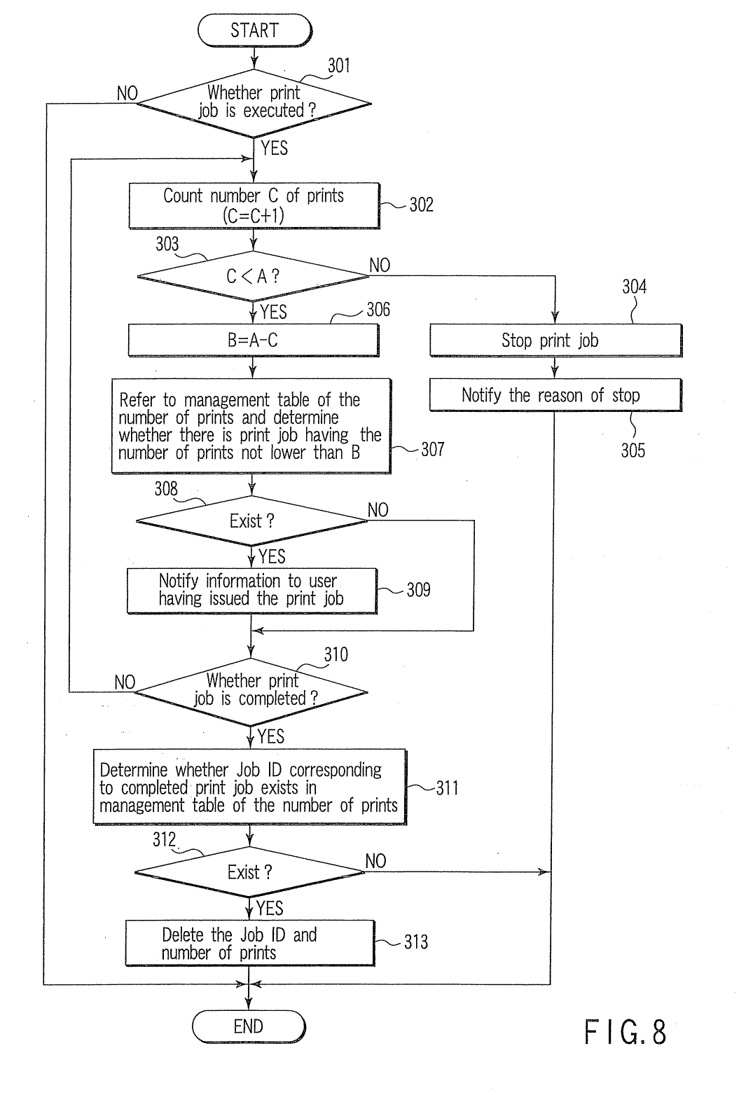

On the other hand, as shown in a flowchart of FIG. 8, when a print job including copy print is being executed (YES at step 301), the number C of prints is counted for each department to which the user having issued the print job under execution belongs (step 302). That is, each time printing of one sheet is completed, the number C of prints is incremented by “1”. It is determined whether the count value C reaches the upper limit value A in the management memory 53 for each department to which the user having issued the print job under execution belongs (step 303).

When the count value C reaches the upper limit value A (NO at step 303), the print job under execution is stopped (step 304). The reason of the stop is notified to the user (step 305). Methods of notification include a display representation in a personal computer, E-mail transmission to the user and the like.

Before the count value C reaches the upper limit value A (YES at step 303), the difference B (=A−C) between the upper limit value A and the count value C is calculated for each department to which the user having issued the print job under execution belongs (step 306). Next, among the respective management tables of the number of prints in the management memory 53, a management table of the number of prints corresponding to the department to which the user having issued the print job under execution belongs is selected, and among the respective numbers of prints registered in the selected management table of the number of prints, it is determined whether there is a print job having the number of prints not lower than the calculated difference B (step 307).

When this determination result is yes (YES at step 308), information that the upper limit value of the number of prints approaches is notified to the user having issued the print job (step 309). Methods of notification include a display representation in a personal computer, E-mail transmission to the user and the like.

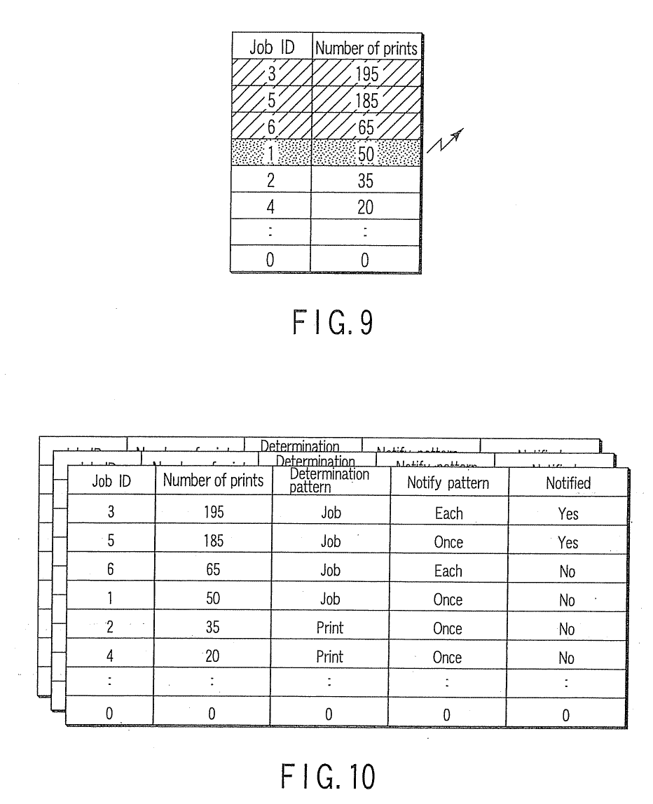

For example, when the upper limit value A is 1000 sheets and the count value C is 960 sheets, the difference B is 40 sheets. In this case, as indicated by dots in FIG. 9, the information is notified to the user having issued a print job of job ID=“1”. When the user having received this notification instructs the start of the print job of job ID=“1”, the print job is completed before the number of prints reaches the upper limit value. Incidentally, in FIG. 9, with respect to print jobs of job IDs=“3”, “5” and “6” indicated by oblique lines, the notification has already been given.

When the print job is completed (YES at step 310), it is determined whether the job ID corresponding to the completed print job exists in each management table of the number of prints in the management memory 53 (step 311). When this determination result is yes (YES at step 312), the job ID and the number of prints are deleted (erased) from the management table of the number of prints (step 313).

[2] A second embodiment will be described.

The upper limit value A of the number of prints is stored in the management memory 53 for each user or each department to which the user belongs, and a plurality of management tables of the number of prints shown in FIG. 10 are stored. These management tables of the number of prints are divided for the respective users or the respective departments.

Each of the management tables of the number of prints includes, in addition to an item of a job ID and an item of the number of prints, an item of a determination pattern, an item of a notify pattern, and an item of Notified to represent whether notification has already been given. The item of the determination pattern represents which of the respective determination patterns of the third determination section of the CPU 50 is set. The item of the notify pattern represents which of notify patterns of the notification section of the CPU 50 is set.

That is, the third determination section of the CPU 50 includes a determination pattern (determination pattern at each time of completion of one print) in which a determination is made in synchronization with the completion of printing of one sheet, and a determination pattern (determination pattern at each time of completion of one job) in which a determination is made in synchronization with the completion of one print job. One of the determination patterns is set by the operation of the control panel 3 or the operation of the personal computer 71 or 72.

The notification section of the CPU 50 includes a notify pattern (Once) in which notification is made only once and a notify pattern (Each) in which notification is repeatedly performed. One of these notify patterns is set by the operation of the control panel 3 or the operation of the personal computer 71 or 72.

The on/off of notification by the notification section of the CPU 50 and the surplus number of prints can also be variably set by the operation of the control panel 3 or the operation of the personal computer 71 or 72.

With respect to the setting of the determination pattern, the notify pattern, the on/off of the notification, and the surplus number of prints, there is setting on the main body level, setting for each department, or setting for each job. The setting for each department has a higher priority than the setting on the main body level, and the setting for each job has a higher priority than the setting for each department.

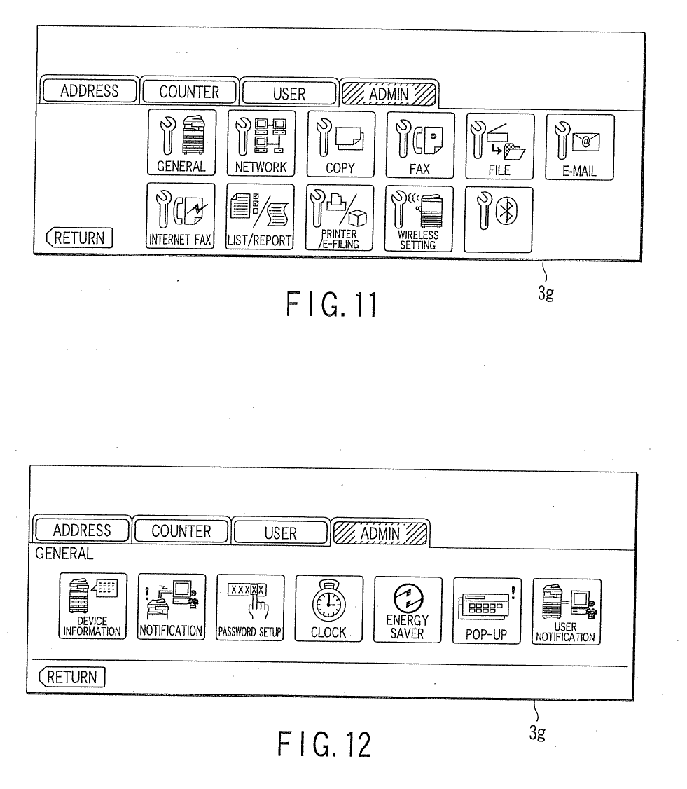

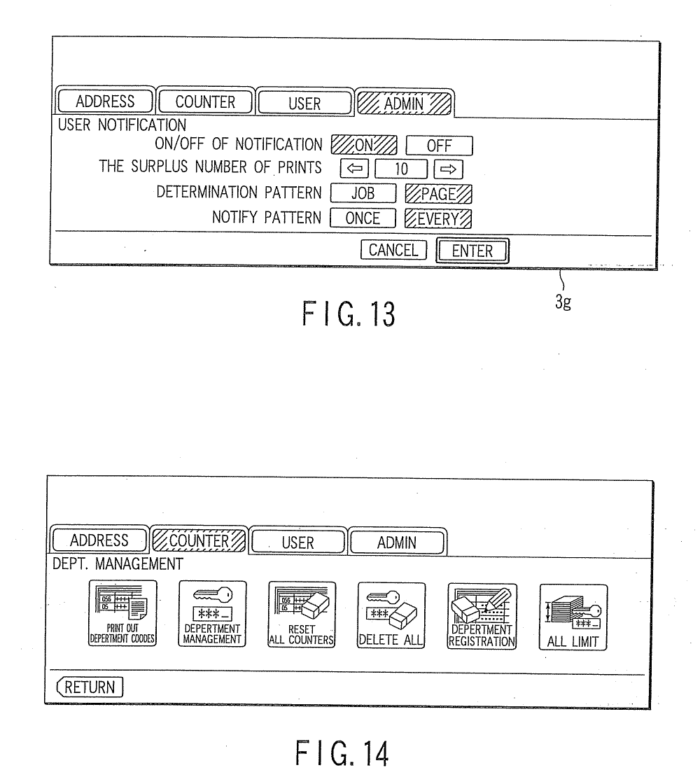

The setting on the main body level is shown in FIGS. 11, 12 and 13. That is, when an ADMIN tag of the liquid crystal display screen 3g of the control panel 3 is touch-operated, the display of the liquid crystal display screen 3g is switched to a menu screen of FIG. 11. On this menu screen, when a GENERAL button is touch-operated, the display of the liquid crystal display screen 3g is switched to a submenu of FIG. 12. On this submenu screen, when a USER NOTIFICATION button is touch-operated, the display of the liquid crystal display screen 3g is switched to a USER NOTIFICATION screen of FIG. 13. The on/off of notification, the surplus number of prints, the determination pattern, and the notify pattern can be set respectively by the touch operation on the USER NOTIFICATION screen.

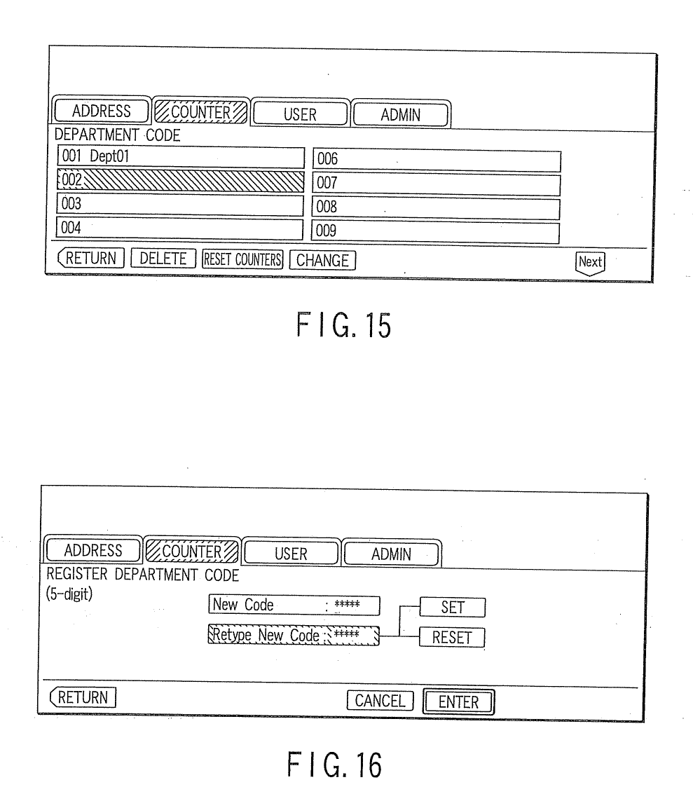

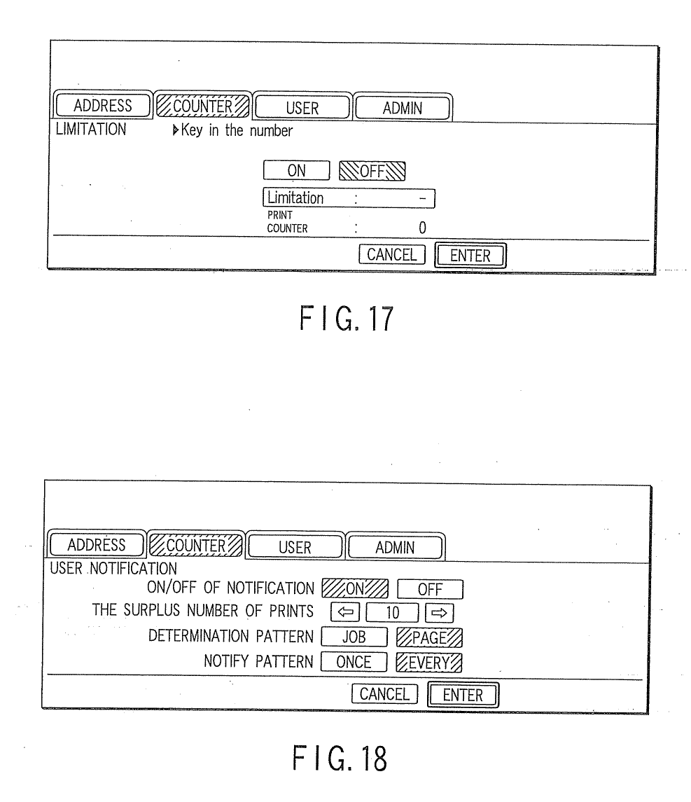

The setting for each department is shown in FIGS. 14, 15, 16, 17 and 18. That is, when a COUNTER tag of the liquid crystal display screen 3g of the control panel 3 is touch-operated, the display of the liquid crystal display screen 3g is switched to a MANAGEMENT screen of FIG. 14. On this MAGNIFICATION screen, a DEPARTMENT REGISTRATION button is touch-operated, the display of the liquid crystal display screen 3g is switched to a DEPARTMENT CODE screen of FIG. 15. On this DEPARTMENT CODE screen, a blank DEPARTMENT button is touch-operated and a CHANGE button is touch-operated, the display of the liquid crystal display screen 3g is switched to a DEPARTMENT CODE registration screen of FIG. 16. On this DEPARTMENT CODE registration screen, when a new DEPARTMENT CODE is inputted and an ENTER button is touch-operated, the display of the liquid crystal display screen 3g is switched to a LIMITATION setting screen of FIG. 17. On this LIMITATION setting screen, when the upper limit value of the number of prints is inputted as the need arises and an ENTER button is touch-operated, the display of the liquid crystal display screen 3g is switched to a USER NOTIFICATION setting screen of FIG. 18. The on/off of notification, the surplus number of prints, the determination pattern, and the notify pattern can be set respectively by the touch operation of the USER NOTIFICATION screen.

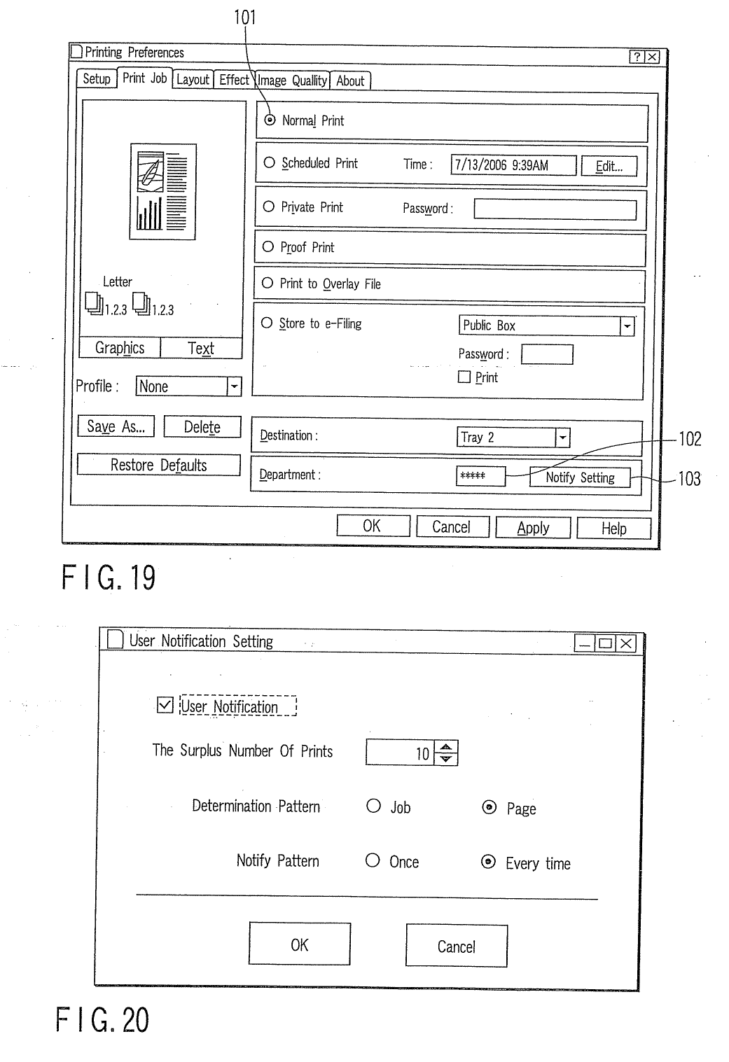

The setting for each job is shown in FIGS. 19 and 20. That is, for example, a print job screen shown in FIG. 19 is displayed on the display of the personal computer 71, and when a Department code is inputted to an input window 102 of DEPARTMENT CODE on the print job and a Notify Setting button 103 is operated, the display of the liquid crystal display screen 3g is switched to a USER NOTIFICATION setting screen of FIG. 20. The surplus number of prints, the determination pattern and the notify pattern can be set respectively by the operation on this USER NOTIFICATION screen.

The other structure is the same as the first embodiment. Thus, its description will be omitted.

The operation will be described.

The print job screen of FIG. 19 is displayed on a display of an external equipment, for example, the personal computer 71, and the print job screen is operated, so that a desired print job can be inputted. The print job screen includes a plurality of check windows 101 to select one of a plurality of print jobs, for example, Normal Print, Scheduled Print, Private Print, Proof Print, Print Overlay File, and Store to e-Filing, an input window 102 of DEPARTMENT CODE to represent a department to which a user belongs, and the like.

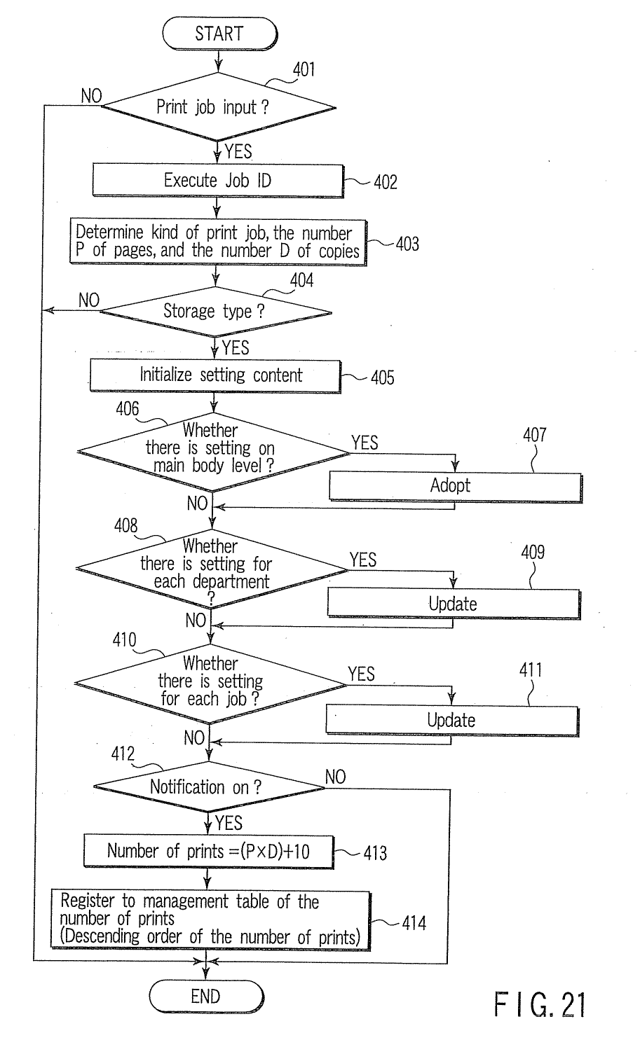

As shown in a flowchart of FIG. 21, when a print job is inputted to the main body 1 (YES at step 401), an arbitrary job ID is issued to the inputted print job (step 402), and the kind of the inputted print job, the number P of pages, and the number D of copies are determined (step 403).

When the kind of the inputted print job is the storage type in which it is once stored and is later executed, for example, a private print job or a schedule print job (YES at step 404), the setting contents of the on/off of notification, the surplus number of prints, the determination pattern, and the notify pattern are initialized (step 405). When the on/off of notification, the surplus number of prints, the determination pattern, and the notify pattern are set on the main body level (YES at step 406), the setting contents on the main body level are adopted (step 407). When the on/off of notification, the surplus number of prints, the determination pattern, and the notify pattern are set on the department level (YES at step 408), the adopted setting contents on the main body level are updated to the setting contents on the department level (step 409). When the surplus number of prints, the determination pattern, the notify pattern, and the determination pattern are set on the job level (YES at step 410), the adopted setting contents on the main body level or the updated setting contents on the department level are updated to the setting contents on the job level (step 411).

When notification on is set (YES at step 412), the number of prints necessary for execution of the inputted print job, together with the surplus number of prints (for example, 10 sheets), is calculated (step 413).

the number of prints=(the number P of pages×the number D of copies)+the surplus number of prints

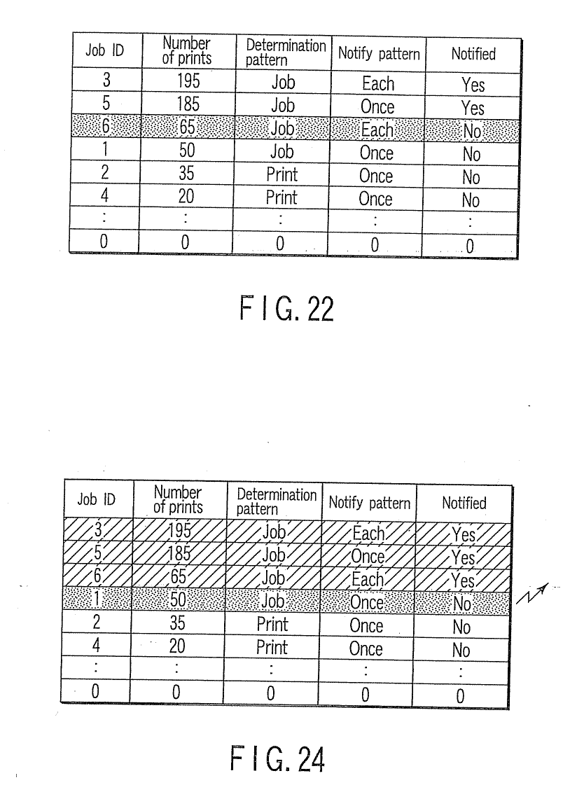

The calculated number of prints is made to correspond to the job ID of the inputted print job and the adopted or updated setting contents (determination pattern and notify pattern), and is registered in the management table of the number of prints in the management memory 53 for the each user or the each department (step 414). The newly registered job ID, the number of prints, and the setting contents are registered in a state where sorting is performed in descending order of the number of prints as indicated by dots in FIG. 22.

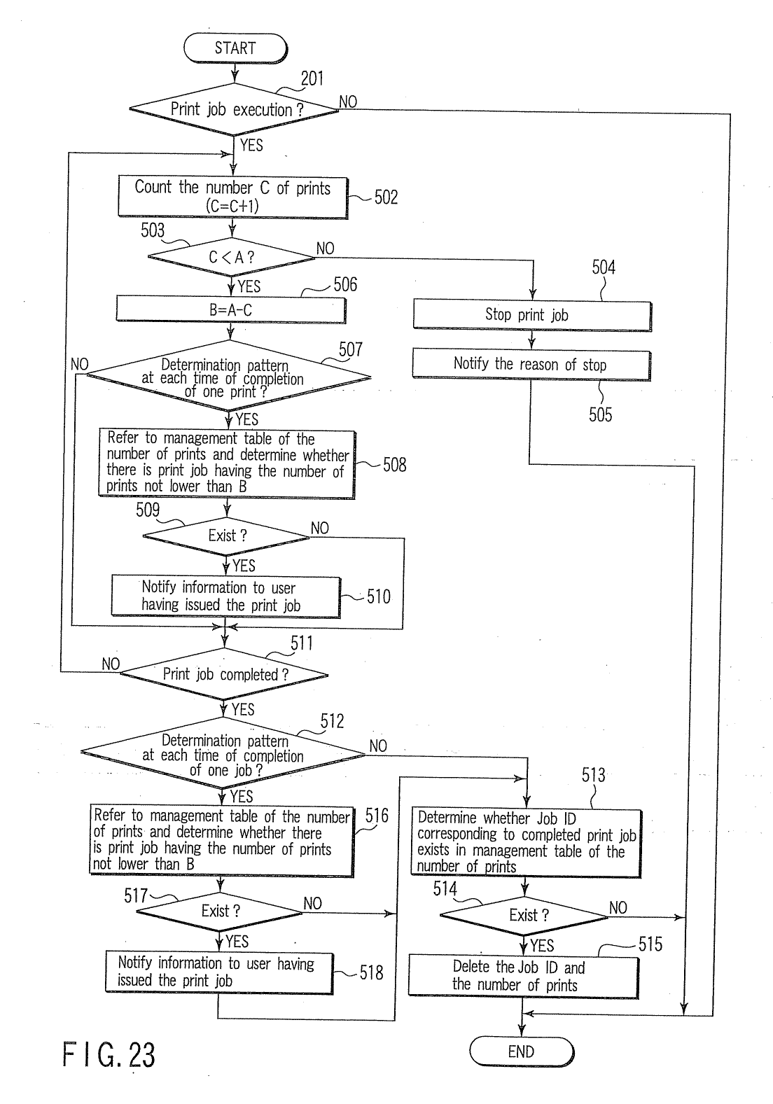

On the other hand, as shown in a flowchart of FIG. 23, when a print job including copy print is being executed (YES at step 501), the number C of prints is counted for each department to which the user having issued the print job under execution belongs (step 502). That is, each time printing of one sheet is completed, the number C of prints is incremented by “1”. It is determined whether the count value C reaches the upper limit value A in the management memory 53 for each department to which the user having issued the print job under execution belongs (step 503).

When the count value C reaches the upper limit value A (NO at step 503), the print job under execution is stopped (step 504). The reason of the stop is notified to the user (step 505). Methods of notification include a display representation in a personal computer, E-mail transmission to the user and the like.

Before the count value C reaches the upper limit value A (YES at step 503), the difference B (=A−C) between the upper limit value A and the count value C is calculated for each department to which the user having issued print job under execution belongs (step 506).

Next, when the judgment pattern (judgment pattern at each time of completion of one print) in which a determination is made in synchronization with completion of printing of one sheet is set (YES at step 507), a management table of the number of prints corresponding to the department to which the user having issued the print job under execution belongs is selected among the management tables of the number of prints in the management memory 53, and it is determined whether there is a print job having the number of prints not lower than the calculated difference B among the respective numbers of prints registered in the selected management table of the number of prints (step 508).

When the determination result is yes (YES at step 509), information that the upper limit value of the number of prints approaches is notified to the user having issued the print job (step 510). Methods of notification include a display representation in a personal computer, E-mail transmission to the user and the like.

For example, when the upper limit value A is 1000 sheets and the count value C is 960 sheets, the difference B is 40 sheets. In this case, as indicated by dots in FIG. 24, the information is notified to the user having issued the print job of job ID=“1”. When the user having received this notification instructs the start of the print job of job ID=“1”, the print job is completed before the number of prints reaches the upper limit value. Incidentally, with respect to print jobs of job IDs=“3”, “5” and “6” indicated by oblique lines in FIG. 24, the notification has already been given.

When the print job is ended (YES at step 511, NO at step 512), it is determined whether the job ID corresponding to the completed print job exists in the respective management tables of the number of prints in the management memory 53 (step 513). When this determination result is yes (YES at step 514), the job ID, the number of prints made to correspond to the job ID, and the setting contents (determination pattern and notify pattern) are deleted (erased) from the management table of the number of prints (step 515).

Incidentally, in the case where the determination pattern (determination pattern at each time of completion of one print) in which the determination is performed in synchronization with completion of printing of one sheet is not set (NO at step 507), but the determination pattern (determination pattern at each time of completion of one job) in which the determination is performed in synchronization with completion of one print job is set (YES at step 512), when the print job is completed (YES at step 511, NO at step 512), processings of steps 516, 517, and 518 having the same contents as the steps 508, 509 and 510 are performed. After the processing of step 518, the processing of step 513 is performed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a storage section to store an upper limit value of the number of prints for each user or each department to which the user belongs;
a first determination section to determine whether, when a print job is inputted, the print job is a storage type in which it is once stored and is later executed;
a first calculation section to calculate, when a determination result of the first determination section is the storage type, the number of prints necessary for execution of the inputted print job, together with the surplus number of prints;
a plurality of management tables of the number of prints in each of which the number of prints calculated by the first calculation section is made to correspond to the inputted print job and is registered for the each user or the each department;
a count section to count the number of prints for the each user or the each department at a time of execution of the print job;
a second determination section to determine whether a count value of the count section reaches the upper limit value in the storage section for the each user having issued the print job under execution or the each department to which the user belongs;
a control section to stop the print job under execution when the count value reaches the upper limit value in determination of the second determination section;
a second calculation section to calculate, when the count value does not reach the upper limit value in the determination of the second determination section, a difference between the upper limit value and the count value for the each user having issued the print job under execution or the each department to which the user belongs;
a third determination section to select a management table of the number of prints corresponding to the user having issued the print job under execution or the department to which the user belongs among the respective management tables of the number of prints, and to determine whether there is a print job having the number of prints not lower than the difference calculated by the second calculation section among the respective numbers of prints registered in the selected management table of the number of prints; and
a notification section to notify, when a determination result of the third determination section is yes, the user having issued the print job that the upper limit value of the number of prints approaches.

2. An apparatus according to claim 1, wherein the print job of the storage type is a private print job executed by password input of a user and a schedule print job executed at a scheduled time.

3. An apparatus according to claim 1, further comprising an operation section to variably set the surplus number of prints.

4. An apparatus according to claim 1, wherein the third determination section has a determination pattern in which the determination is made in synchronization with completion of printing of one sheet, and a determination pattern in which the determination is made in synchronization with completion of one print job.

5. An apparatus according to claim 4, further comprising an operation section to set one of the respective determination patterns.

6. An apparatus according to claim 1, wherein the notification section has a notify pattern in which the notification is made only once, and a notify pattern in which the notification is made repeatedly.

7. An apparatus according to claim 6, further comprising an operation section to set one of the respective notify patterns.

8. An image forming apparatus comprising:
storage means for storing an upper limit value of the number of prints for each user or each department to which the user belongs;
first determination means for determining whether, when a print job is inputted, the print job is a storage type in which it is once stored and is later executed;
first calculation means for calculating, when a determination result of the first determination means is the storage type, the number of prints necessary for execution of the inputted print job, together with the surplus number of prints;
a plurality of management means of the number of prints in each of which the number of prints calculated by the first calculation means is made to correspond to the inputted print job and is registered for the each user or the each department;
count means for counting the number of prints for the each user or the each department at a time of execution of the print job;
second determination means for determining whether a count value of the count means reaches the upper limit value in the storage means for the each user having issued the print job under execution or the each department to which the user belongs;
control means for stopping the print job under execution when the count value reaches the upper limit value in determination of the second determination means;
second calculation means for calculating, when the count value does not reach the upper limit value in the determination of the second determination means, a difference between the upper limit value and the count value for the each user having issued the print job under execution or the each department to which the user belongs;
third determination means for selecting a management table of the number of prints corresponding to the user having issued the print job under execution or the department to which the user belongs among the respective management tables of the number of prints, and for determining whether there is a print job having the number of prints not lower than the difference calculated by the second calculation means among the respective numbers of prints registered in the selected management table of the number of prints; and
notification means for notifying, when a determination result of the third determination means is yes, the user having issued the print job that the upper limit value of the number of prints approaches.

9. An apparatus according to claim 8, wherein the print job of the storage type is a private print job executed by password input of a user and a schedule print job executed at a scheduled time.

10. An apparatus according to claim 8, further comprising operation means for variably setting the surplus number of prints.

11. An apparatus according to claim 8, wherein the third determination means has a determination pattern in which the determination is made in synchronization with completion of printing of one sheet, and a determination pattern in which the determination is made in synchronization with completion of one print job.

12. An apparatus according to claim 11, further comprising operation means for setting one of the respective determination patterns.

13. An apparatus according to claim 8, wherein the notification means has a notify pattern in which the notification is made only once, and a notify pattern in which the notification is made repeatedly.

14. An apparatus according to claim 13, further comprising operation means for setting one of the respective notify patterns.

15. A control method of an image forming apparatus, comprising:
storing an upper limit value of the number of prints for each user or each department to which the user belongs;
determining whether, when a print job is inputted, the print job is a storage type in which it is once stored and is later executed;
calculating, when the determination result is the storage type, the number of prints necessary for execution of the inputted print job, together with the surplus number of prints;
making the calculated number of prints to correspond to the inputted print job and registering it for the each user or the each department;
counting the number of prints for the each user or the each department at a time of execution of the print job;
determining whether the count value reaches the upper limit value for the each user having issued the print job under execution or the each department to which the user belongs;
stopping the print job under execution when the count value reaches the upper limit value in the determination;
calculating, when the count value does not reach the upper limit value in the determination, a difference between the upper limit value and the count value for the each user having issued the print job under execution or the each department to which the user belongs;
determining whether there is a print job having the number of prints not lower than the calculated difference among the respective registered numbers of prints; and
notifying, when the determination result is yes, the user having issued the print job that the upper limit value of the number of prints approaches.
